(19) United States
(12) Patent Application Publication
(10) Pub. No.: US 2024/0133525 A1
(43) Pub. Date: Apr. 25, 2024

(54) RETRACTABLE QUILL

(71) Applicant: XTENDED HYDRAULIC & MACHINE INC., Emerald Park (CA)

(72) Inventor: Robert TEBB, Emerald Park (CA)

(21) Appl. No.: 18/546,607

(22) PCT Filed: Feb. 16, 2022
(86) PCT No.: PCT/CA2022/000004

§ 371 Date: Aug. 15, 2023

Related U.S. Application Data
(60) Provisional application No. 63/150,208, filed on Feb. 17, 2021.

(51) Int. Cl. F17D 3/10; F17D 3/12

(52) U.S. Cl. CPC F17D 3/10; F17D 3/12

(57) ABSTRACT

Retractable quills for use with a pipe or vessel containing a fluid, and methods of operation thereof, are described. The retractable quill has a cylinder and a hollow rod slidably disposed within the cylinder, the hollow rod having a first end configured to be inserted into the pipe or vessel in fluid communication with the fluid. The retractable quill also has a drive system configured to move the hollow rod within the cylinder between an extended position where the first end of the hollow rod is inserted into the pipe or vessel and within the fluid and a retracted position where the first end of the hollow rod is outside of the pipe or vessel. The retractable quill may be configured to maintain a positive pressure seal when the hollow rod is moved between the extended position and the retracted position.

### FIELD OF THE INVENTION

The present invention relates generally to quills, and more particularly to retractable quills.

### BACKGROUND OF THE INVENTION

Injection and sampling quills are used in various industries, such as the oil and gas, mining, water treatment, chemical processing, and hydroelectric industries. Injection quills can be used to inject fluid, such as corrosion inhibitors or scale inhibitors, into a pipeline or vessel. Sampling quills can be used to obtain a sample from a pipeline or vessel for analytical purposes.

At times, quills must be removed from a pipeline or vessel. This may be done for maintenance purposes, such as for the inspection and replacement of parts of a quill. Quills also need to be removed prior to “pigging” a pipeline, i.e. using a pipeline inspection gauge to perform maintenance operations such as cleaning and inspecting a pipeline.

The process of removing a quill is a manual process involving loosening packing nuts, backing out the quill, closing an isolation valve, and finally removing the quill itself. While threaded rod guides or small chains are often provided as safety features, they may not be sufficient at high pressures. Therefore, when dealing with pressurized fluids, such as in gas and oil pipelines in which the line pressure can range from about 800 to about 1400 PSI, technicians must shut off the flow and drain the pipeline in order to safely retract a quill. The resultant downtime is, of course, undesirable.

There is a need for a retractable quill that can be safely retracted from within a pipeline without having to shut off flow to the pipeline or drain the pipeline. In addition, a device that can allow for remote-controlled, automated retraction of a quill would be beneficial.

### SUMMARY OF THE INVENTION

The following presents a simplified summary of the disclosure in order to provide a basic understanding to the reader. This summary is not an extensive overview of the disclosure and it does not necessarily identify key/critical elements of the invention or delineate the scope of the invention. Its sole purpose is to present some concepts disclosed herein in a simplified form as a prelude to the more detailed description that is presented later.

The present invention provides a retractable quill for use with a pipe or vessel containing a fluid, the pipe or vessel being configured to receive a hollow rod of the retractable quill at a reception point. The retractable quill has a cylinder having a first end and a second end. The hollow rod is slidably disposed within the cylinder, the hollow rod having a first end configured to extend through the second end of the cylinder and be inserted into the pipe or vessel at the reception point in fluid communication with the fluid. The retractable quill also has a drive system configured to move the hollow rod within the cylinder between an extended position where the first end of the hollow rod is inserted into the pipe or vessel and within the fluid and a retracted position where the first end of the hollow rod is outside of the pipe or vessel. The retractable quill is configured to attach to the pipe or vessel and encompass the reception point.

In one embodiment, the second end of the cylinder is configured to attach to the pipe or vessel and encompass the reception point.

In another embodiment, the retractable quill also has a dampener flange connected to the second end of the cylinder, and a velocity ring provided in the dampener flange. In such an embodiment, the dampener flange is configured to attach to the pipe or vessel and encompass the reception point.

In yet another embodiment, the retractable quill has an isolation valve connected to the second end of the cylinder, the isolation valve being configured to attach to the pipe or vessel and encompass the reception point.

In a further embodiment, the retractable quill has an isolation valve having a first end and a second end, the first end of the isolation valve connected to the second end of the cylinder, a dampener flange connected to the second end of the isolation valve, and a velocity ring provided in the dampener flange. In such an embodiment, the dampener flange is configured to attach to the pipe or vessel and encompass the reception point.

In some embodiments, the pipe or vessel is pressurizable, and the retractable quill is configured to maintain a positive pressure seal when the hollow rod is moved between the extended position and the retracted position. For example, the retractable quill may maintain a positive pressure seal when the fluid is at a pressure of up to at least 2200 PSI.

The retractable quill may be an injection quill or a sampling quill.

In certain embodiments, the drive system is remote-controlled and/or automated. The drive system may be a hydraulic drive, a pneumatic drive, or an electrical drive. The electrical drive may, for example, be a servo drive.

In some embodiments, the hollow rod may be made of a first rod and a second rod that are detachably connected to one another.

In embodiments where there is an isolation valve, the isolation valve may be remote-controlled and/or automated. The isolation valve may, for example, be a double block and bleed ball valve.

In certain embodiments, the retractable quill may have one or more position sensors to track the position of the hollow rod as it moves between the extended position and the retracted position.

In some embodiments, the retractable quill may also have an RFID tag.

The present invention also provides a method of operating the retractable quill. The method includes moving the hollow rod from the retracted position to the extended position using the drive system; either injecting a chemical into the fluid or removing a sample from the fluid; and moving the hollow rod from the extended position to the retracted position using the drive system, where the drive system is remote-controlled and/or automated. In some embodiments, the pipe or vessel is pressurizable, and the retractable quill is configured to maintain a positive pressure seal when the hollow rod is moved between the extended position and the retracted position.

The present invention also provides a further method of operating a retractable quill when the retractable quill has an isolation valve. The method includes opening the isolation valve; moving the hollow rod from the retracted position to the extended position using the drive system; either injecting a chemical into the fluid or removing a sample from the fluid; moving the hollow rod from the extended position to the retracted position using the drive system; and closing the isolation valve, where the drive system is remote-controlled and/or automated, and the isolation valve is remote-controlled and/or automated. In some embodiments, the pipe or vessel is pressurizable, and the retractable quill is configured to maintain a positive pressure seal when the hollow rod is moved between the extended position and the retracted position.

### BRIEF DESCRIPTION OF THE DRAWINGS

For a more complete understanding of the present disclosure, the invention is illustrated in the figures of the accompanying drawings, which are meant to be exemplary and not limiting, and in which like reference numbers indicate like features.

FIG. 1 is a perspective view of a pipe and an injection quill in accordance with one embodiment of the present invention.

FIG. 2A is a cross-sectional view of the pipe and quill of FIG. 1, taken along lines 2A-2A.

FIG. 2B is an enlarged fragmentary view of FIG. 2A. FIG. 2C is an enlarged fragmentary view of FIG. 2A. FIG. 2D is an enlarged fragmentary view of FIG. 2A.

FIG. 3A is a perspective view of a first rod in accordance with an embodiment of the present invention. FIG. 3B is a cross-sectional view of the first rod of FIG. 3A, taken along lines 3B-3B of FIG. 3A.

FIG. 4A is a perspective view of a second rod in accordance with an embodiment of the present invention. FIG. 4B is a cross-sectional view of the second rod of FIG. 4A, taken along lines 4B-4B of FIG. 4A.

FIG. 5A is a perspective view of a piston in accordance with an embodiment of the present invention. FIG. 5B is a cross-sectional view of the piston of FIG. 5A, taken along lines 5B-5B of FIG. 5A.

FIG. 6A is a perspective view of a cylinder in accordance with an embodiment of the present invention. FIG. 6B is a cross-sectional view of the cylinder of FIG. 6A, taken along lines 6B-6B of FIG. 6A.

FIG. 7A is a perspective view of a sleeve in accordance with an embodiment of the present invention. FIG. 7B is a cross-sectional view of the sleeve of FIG. 7A, taken along lines 7B-7B of FIG. 7A.

FIG. 8A is a perspective view of a cylinder gland in accordance with an embodiment of the present invention. FIG. 8B is a cross-sectional view of the cylinder gland of FIG. 8A, taken along lines 8B-8B of FIG. 8A.

FIG. 9A is a perspective view of a sleeve gland in accordance with an embodiment of the present invention. FIG. 9B is a cross-sectional view of the sleeve gland of FIG. 9A, taken along lines 9B-9B of FIG. 9A.

FIG. 10A is a top view of a pipe and an injection quill in accordance with an alternate embodiment of the present invention. FIG. 10B is a cross-sectional perspective view of the injection quill of FIG. 10A, taken along lines 10B-10B of FIG. 10A. FIG. 10C is an enlarged fragmentary view of FIG. 10B. FIG. 10D is an enlarged fragmentary view of FIG. 10B. FIG. 10E is an enlarged fragmentary view of FIG. 10B. FIG. 10F is an enlarged fragmentary view of FIG. 10B.

FIG. 11 is a perspective view of a pipe (shown in broken lines) and an injection quill in accordance with a different embodiment of the present invention.

FIG. 12A is a side view of the pipe (shown in broken lines) and quill of FIG. 11. FIG. 12B is a cross-sectional view of the pipe (shown in broken lines) and quill of FIG. 11, taken along lines 12B-12B of FIG. 12A.

FIG. 13A is a top view of the pipe (shown in broken lines) and quill of FIG. 11. FIG. 13B is a cross-sectional view of the pipe (shown in broken lines) and quill of FIG. 11, taken along lines 13B-13B of FIG. 13A.

FIG. 14 is an enlarged fragmentary view of FIG. 13B.

FIG. 15 is an enlarged fragmentary view of FIG. 13B.

FIG. 16 is an enlarged fragmentary view of FIG. 13B.

FIG. 17A is a top view of an upper cylinder gland in accordance with an embodiment of the present invention. FIG. 17B is a cross-sectional view of the upper cylinder gland of FIG. 17A, taken along lines 17B-17B of FIG. 17A. FIG. 17C is a perspective view of the upper cylinder gland of FIG. 17A.

FIG. 18A is a side view of a piston in accordance with an embodiment of the present invention. FIG. 18B is a cross-sectional view of the piston of FIG. 18A, taken along lines 18B-18B of FIG. 18A. FIG. 18C is a perspective view of the piston of FIG. 18A.

FIG. 19A is a side view of a lower cylinder gland in accordance with an embodiment of the present invention. FIG. 19B is a cross-sectional view of the lower cylinder gland of FIG. 19A, taken along lines 19B-19B of FIG. 19A. FIG. 19C is a perspective view of the lower cylinder gland of FIG. 19A.

FIG. 20A is a side view of a quill retaining ring (with the cross-section shown in broken lines) in accordance with an embodiment of the present invention. FIG. 20B is a perspective view of the quill retaining ring of FIG. 20A.

FIG. 21A is a side view of a cylinder (with the cross-section shown in broken lines) in accordance with an embodiment of the present invention. FIG. 21B is a perspective view of the cylinder of FIG. 21A.

FIG. 22A is a side view of a second rod (with the cross-section shown in broken lines) in accordance with an embodiment of the present invention. FIG. 22B is a perspective view of the second rod of FIG. 22A.

FIG. 23A is a side view of a first rod (with the cross-section shown in broken lines) in accordance with an embodiment of the present invention. FIG. 23B is a perspective view of the first rod of FIG. 23A.

FIG. 24A is a side view of a ball valve (with the cross-section shown in broken lines) in accordance with an embodiment of the present invention. FIG. 24B is a perspective view of the ball valve of FIG. 24A.

FIG. 25A is a top view of a flange in accordance with an embodiment of the present invention. FIG. 25B is a cross-sectional view of the flange of FIG. 25A, taken along lines 25B-25B of FIG. 25A. FIG. 25C is a perspective view of the flange of FIG. 25A.

FIG. 26A is a side view of a velocity ring (with the cross-section shown in broken lines) in accordance with an embodiment of the present invention. FIG. 26B is a perspective view of the velocity ring of FIG. 26A.

FIG. 27A is a top view of a dampener flange in accordance with an embodiment of the present invention. FIG. 27B is a cross-sectional view of the dampener flange of FIG. 27A, taken along lines 27B-27B of FIG. 27A. FIG. 27C is a perspective view of the dampener flange of FIG. 27A.

### DETAILED DESCRIPTION

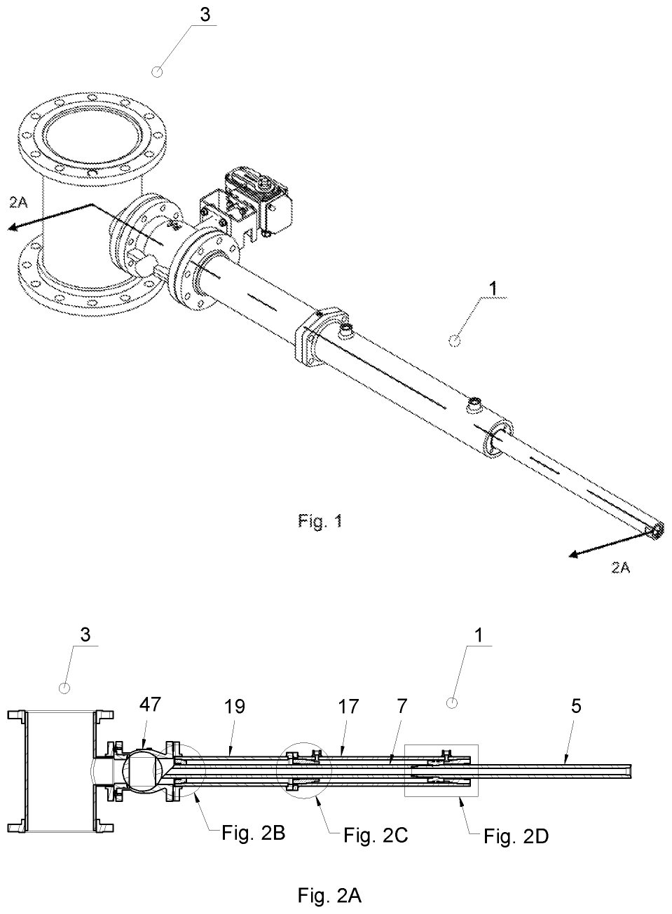

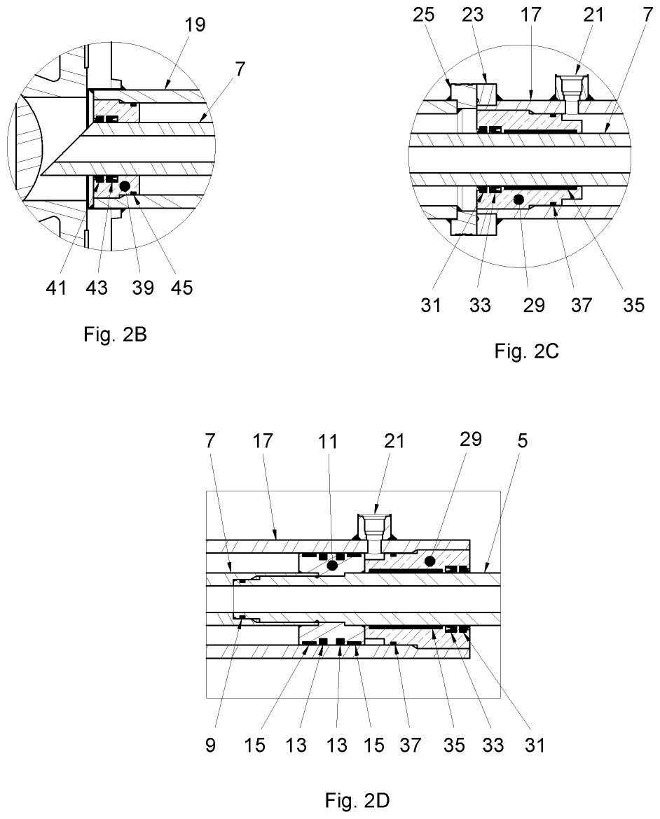

Disclosed herein are chemical injection and sampling quills for use with pipes or vessels (such as tanks, chemical reactors, or high temperature boilers), including pressurized pipes or vessels. In one embodiment, and as shown in FIGS. 1 and 2A, an injection quill having a hydraulic or pneumatic drive system, quill 1, may be attached to and encompass a reception point at a flange at pipe 3. This can, for example, be done by the use of nuts and bolts, with an o-ring provided between quill 1 and pipe 3 to establish a seal. Quill 1 may be dimensioned such that it can be used with a flange already in place at pipe 3 (which may have, for example, been used with a quill as known in the prior art).

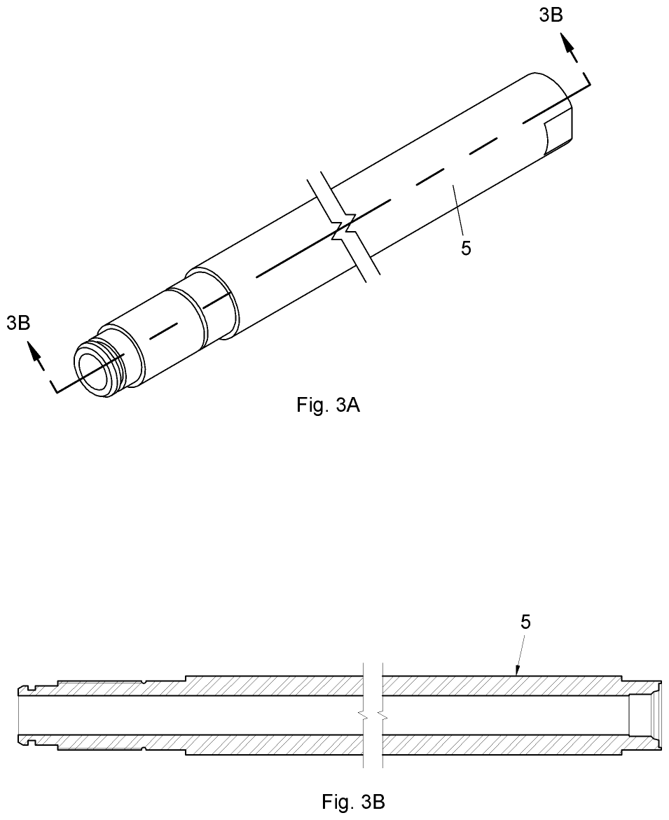

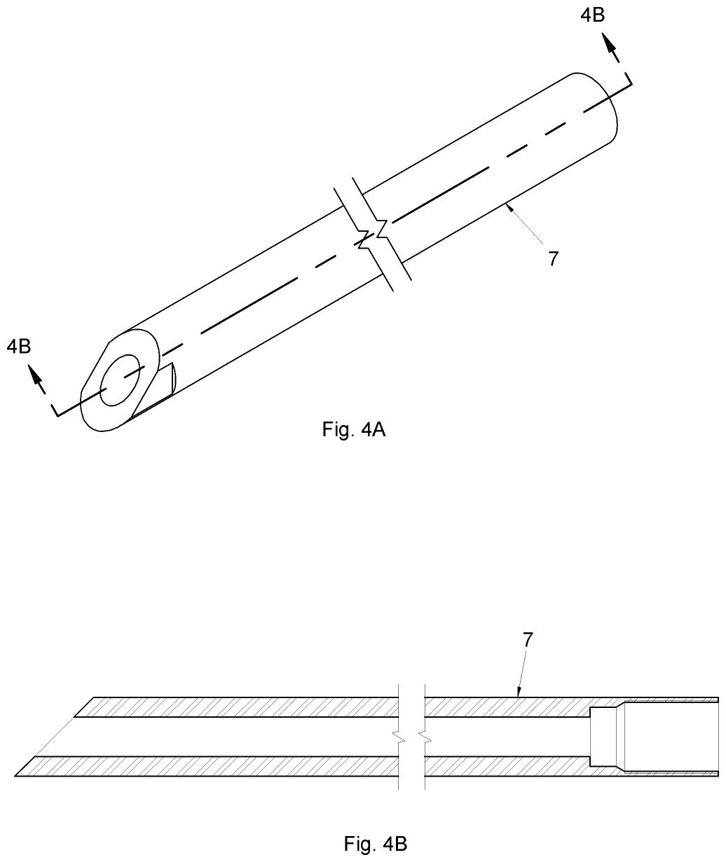

As shown in FIGS. 3A, 3B, 4A and 4B, quill 1 comprises a hollow rod, which may be provided in the form of two hollow rods detachably connected to one another, first rod 5 and second rod 7. First rod 5 may, for example, be about 33½ inches in length with an external diameter of about 2 inches, and an internal diameter of about 1 inch. Second rod 7 may, for example, be about 41¼ inches in length with an external diameter of about 2 inches, and an internal diameter of about 1 inch. First rod 5 and second rod 7 may be made of 316 grade stainless steel, zinc plated carbon steel or any other material specially selected based on the application in which quill 1 will be used (for example, the material used may be selected based on its corrosion or abrasion resistance properties with respect to a particular chemical expected to be injected through quill 1 into pipe 3). As shown in FIGS. 2A and 2D, first rod 5 and second rod 7 are connected together. This may, for example, be done by threading and using a groove with an o-ring, such as o-ring 9 in FIG. 2D, to help seal the connection. The free end of second rod 7 extends into pipe 3 when quill 1 is in its extended position. In some embodiments, the free end of second rod 7 may be angled. Use of detachably connected first rod 5 and second rod 7 means that if second rod 7 becomes corroded it can easily be replaced.

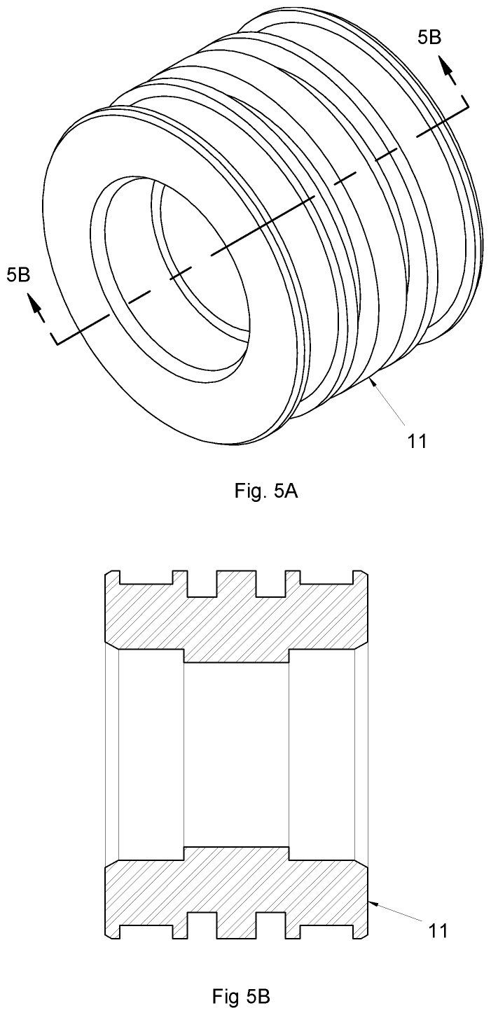

Piston 11, as shown in FIGS. 2A, 2D, 5A, and 5B, may be provided on first rod 5 near the end of first rod 5 connected to second rod 7. Piston 11 may, for example, be made of Dura-Bar™ cast iron, and may be about 2½ inches in length with an external diameter of about 3½ inches and an internal diameter of about 1.8 inches. Piston 11 may be provided with one or more piston seals 13 and/or one or more piston wear bands 15. The one or more piston seals 13 provide sealing, as further outlined below.

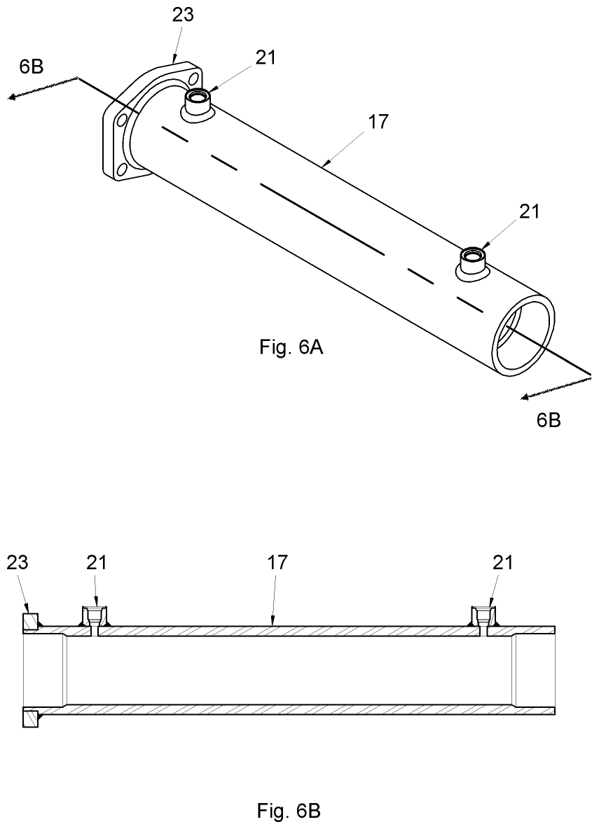

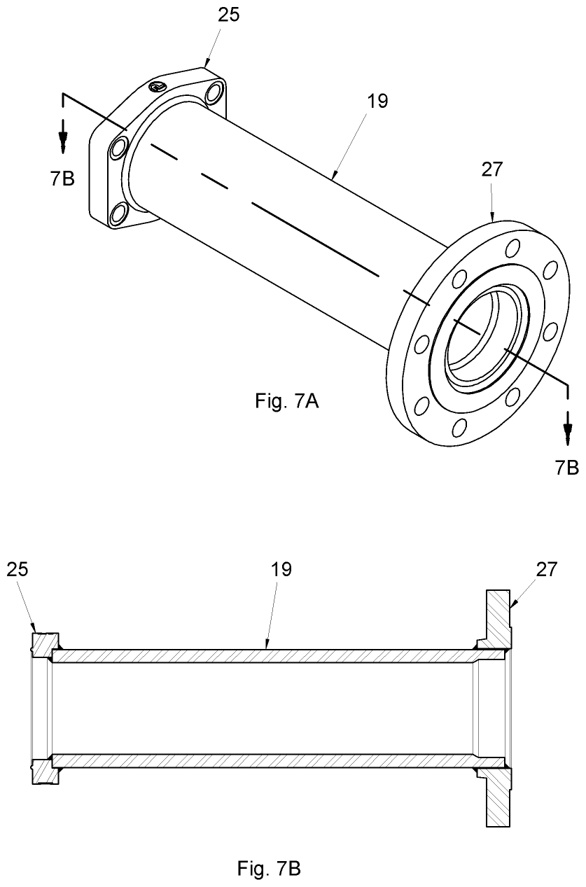

First rod 5 and second rod 7 with piston 11 are slidably disposed within cylinder 17 and sleeve 19, as shown in FIGS. 2A, 2C, 6A, 6B, 7A, and 7B. Cylinder 17 may also have two ports 21 and a flange 23. Cylinder 17 may, for example, be made of A513 microhoned tubing, and may be about 27½ inches in length with an external diameter of about 4½ inches and an internal diameter of about 3½ inches. Flange 23 may be made of 44 W grade steel or 316 Stainless Steel. Flange 23 and cylinder 17 may be manufactured separately and welded together. Sleeve 19 may have a first flange 25 and a second flange 27, and may have one or more bleed ports (not shown) for the removal of liquid in case of a leak. Sleeve 19 may, for example, be made of C1026 (DOM) steel tubing or 316 Stainless Steel, and may be about 17¼ inches in length with an external diameter of about 4½ inches and an internal diameter of about 3½ inches. Cylinder 17 and sleeve 19 may be connected at cylinder flange 23 and sleeve first flange 25 by, for example, the use of nuts and bolts and optionally with an added o-ring for extra sealing.

In an alternate embodiment, cylinder 17 and sleeve 19 may be of unitary construction, rather than being made of two separate pieces connected together.

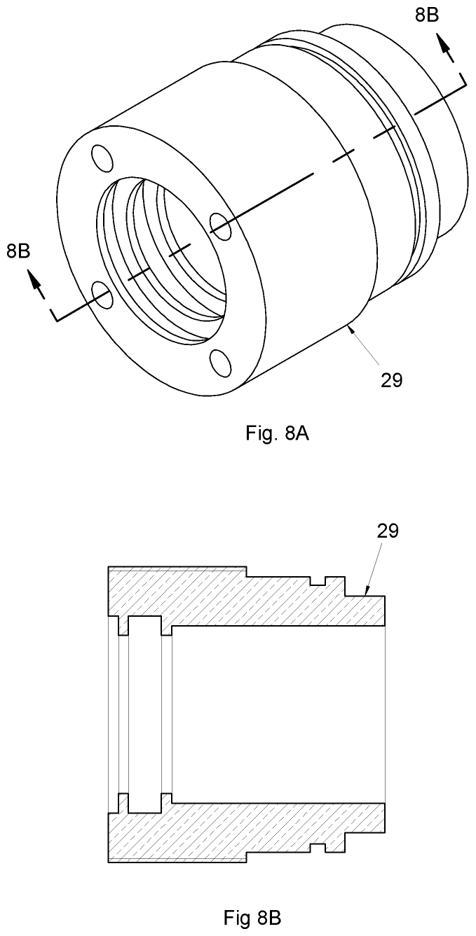

Two cylinder glands 29, as shown in FIGS. 8A and 8B, may be placed within cylinder 17 at each end of cylinder 17, as shown in FIGS. 2A, 2C and 2D. Cylinder glands 29 may or may not be of the same shape and dimensions, and may or may not be made of the same material. Cylinder glands 29 may, for example, be made of SAE 660 grade bronze, and may be about 4 inches in length with an external diameter of about 3¾ inches and an internal diameter of about 2 inches. In some embodiments, cylinder glands 29 may each have one or more rod wipers 31, rod seals 33, rod wear bands 35 and/or gland o-rings 37, as shown in FIGS. 2C and 2D. Rod seals 33 and gland o-rings 37 help to create a seal.

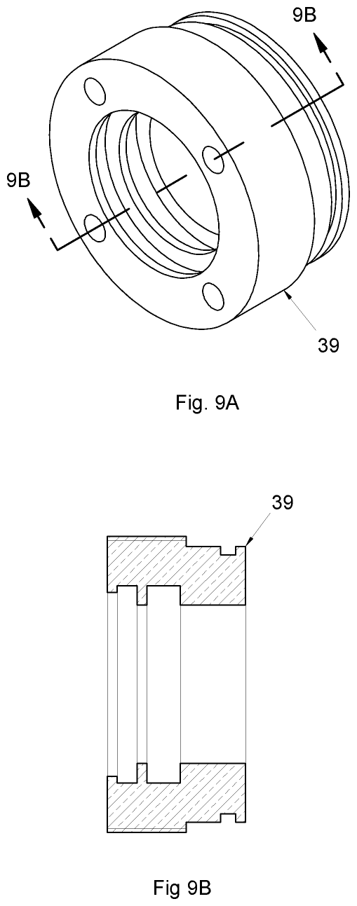

Sleeve gland 39, as shown in FIGS. 9A and 9B, may be placed within sleeve 19 at the end of sleeve 19 facing away from cylinder 17, as shown in FIGS. 2A and 2B. Sleeve gland 39 may, for example, be made of SAE 660 grade bronze, and may be about 1¾ inches in length with an external diameter of about 3¾ inches and an internal diameter of about 2 inches. In some embodiments, sleeve gland 39 may have one or more rod wipers 41, rod seals 43, and/or gland o-rings 45, as shown in FIG. 2B. Rod seal 43 and gland o-ring 45 help to create a seal.

A flexible injection (or sampling) line (not shown) may be attached to the free end of first rod 5, and used to inject chemicals into the pipeline (or to remove samples, in the case of a sampling quill). The free end of first rod 5 may be threaded to allow for a positive seal with the injection line.

In some embodiments, an isolation valve 47, which may be a ball valve such as the VSI-V-4-1010-X manufactured by Valve Solutions™ or the Atlas Series™ cast trunnion double block and bleed ball valve made by CNC Flow Control™, may be added to quill 1. Isolation valve 47 may, for example, be solenoid-operated. When present, isolation valve 47 is located between sleeve 19 and pipe 3. Isolation valve 47 may be closed to allow for removal of quill 1 (or parts thereof) for maintenance without needing to shut off flow in the pipeline. In addition, isolation valve 47 may be closed when pigging the pipeline in order to help prevent debris within pipe 3 from entering quill 1. Use of a double block and bleed ball valve also allows one to purge any air that may be trapped within quill 1 during installation.

In some embodiments (not shown), a dampener flange holding a velocity ring may be provided between isolation valve 47 and pipe 3. Isolation valve 47 and the dampener flange may be connected by, for example, the use of nuts and bolts and optionally with a gasket for extra sealing. The gasket may, for example, be a Flexitallic™ Spiral Wound Gasket. The velocity ring dampens any vibration of first rod 5 and second rod 7 that may occur when second rod 7 is extended into pipe 3 and exposed to pressure from the flow in pipe 3.

In certain embodiments, one or more position sensors (not shown) may be added to quill 1 to track the position of quill 1 in its stroke, and in particular, how far it extends into pipe 3. Position sensors may be mounted internally or externally. For example, a magnetostrictive external position sensor can be used to identify the position of the quill. The sensor may be mounted externally on the side of quill 1. One or more strong magnets, such as strong rare-earth magnets, may be installed around piston 11. This can be done, for example, by the use of pockets to house the magnets. In some embodiments, there may be eight or more magnets around piston 11. The externally mounted position sensor measures the position of the magnets through cylinder 17. Use of multiple magnets on piston 11 tends to provide more accurate measurements of the position of piston 11 in the case that piston 11 rotates over time. Use of a position sensor provides information that assists with remote operation of quill 1. In addition, it allows operators to know better where in the flow a chemical will be injected (or, in the case of a sampling quill, to know better where in the flow a sample is drawn from).

In some embodiments (not shown), RFID tags may be mounted on the exterior of cylinder 17 and used to store information such as maintenance data and location.

In some embodiments, a flushing system may be added to clean the quill. After retracting quill 1 and pigging the pipeline, debris may accumulate at isolation valve 47 or, in embodiments where there is no isolation valve, at sleeve 19. Before extending second rod 7 into pipe 3, one may first open isolation valve 47 (if present) and flush quill 1 with a flushing fluid before allowing second rod 7 to enter pipe 3. This tends to prevent debris from entering second rod 7. This flushing system may be automated.

In use, quill 1 may be operated via a hydraulic drive system (using, for example, oil) or a pneumatic drive system. Use of a hydraulic or pneumatic drive system allows for quill 1 to be automated and/or remotely operated. When present, isolation valve 47 may also be automatically and/or remotely operated, and may be opened before extension of quill 1, and closed after retraction of quill 1. Similar to a double-acting hydraulic or pneumatic cylinder, fluid can enter and exit cylinder 17 through ports 21. Fluid entering one of ports 21 exerts a force on piston 11, moving the piston 11 (and as a result, both of first rod 5 and second rod 7) and pushing fluid out of the other port 21 until piston 11 contacts one of cylinder glands 29. Rod wipers 31 act to wipe first rod 5 and second rod 7 and prevent dust and debris from entering cylinder 17 during piston strokes. Similarly, rod wiper 41 acts to wipe second rod 7 and prevent debris from entering sleeve 19 during piston strokes. In certain embodiments, quill 1 is designed so that during retraction, the free end of second rod 7 does not enter cylinder 17, but remains within sleeve 19, meaning that any possible corrosion of second rod 7 (due, for example, to chemical injected into the pipeline via quill 1, or to flow within the pipeline) does not affect the hydraulic or pneumatic drive system.

Cylinder glands 29 (via rod seals 33, gland o-rings 37 and rod wipers 31) help to create a positive pressure seal at cylinder 17 during piston strokes. Additional sealing is provided by the sleeve gland 39 (via rod seal 43, gland o-ring 45, and rod wiper 41) and piston 11 (via piston seals 13). The seal is maintained even when the quill is moved between its retracted and extended positions. As noted above, in certain embodiments, quill 1 is designed so that during retraction, the free end of second rod 7 does not enter cylinder 17, but remains within sleeve 19, meaning that any possible corrosion of second rod 7 (due, for example, to chemical injected into the pipeline via quill 1, or to flow within the pipeline) does not compromise sealing at cylinder 17.

A sampling quill can be made in a similar fashion to the injection quill described above, but the free end of the second rod, which extends into the pipe when the quill is in its extended position, sometimes has a different configuration. In some embodiments, the free end of the second rod of a sampling quill has the same configuration as that shown for quill 1 above. In other embodiments, the free end of the second rod of a sampling quill is modified in order to increase turbulence, and may have small holes or perforations at the angled tip, or may have a tip shaped similar to a spoon.

In an alternate embodiment, the quill may have an electrical drive system, such as a servo drive system, rather than a hydraulic or pneumatic drive system. A servo drive can be used in many settings and can be beneficial particularly if the quill is expected to be operated at low temperatures at which a hydraulic drive can tend to be “sluggish”, such as below about −35° C.

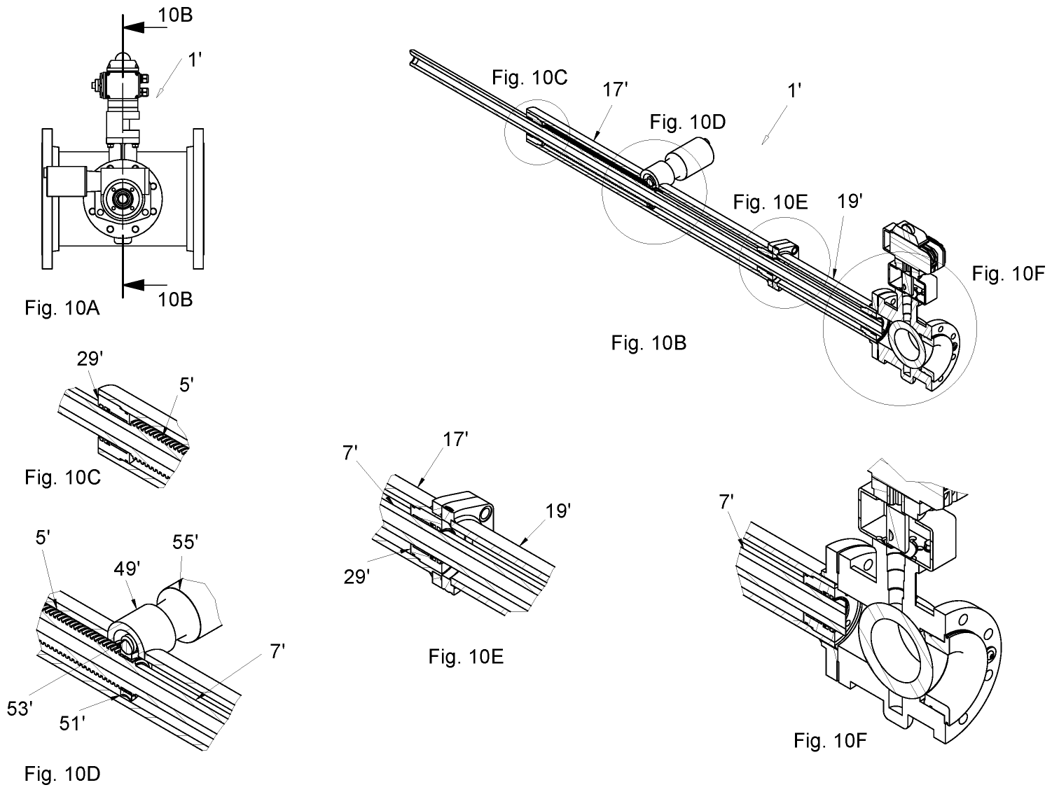

The skilled person will understand how to modify the quill described above to use a servo drive. In particular, the cylinder of a quill with a servo drive system will differ from the cylinder of a quill with a hydraulic or pneumatic drive system. FIGS. 10A, 10B, 10C, 10D, 10E and 10F show part of quill 1′, which is a quill having a servo drive system in accordance with one embodiment of the present invention. Quill 1′ has a first rod 5′ connected to second rod 7′. These rods are placed within cylinder 17′ having cylinder glands 29′ placed at each end of cylinder 17′. Cylinder 17′ may be connected to sleeve 19′. While second rod 7′, cylinder glands 29′ and sleeve 19′ are similar to their corresponding parts in quill 1 having a hydraulic or pneumatic drive system, amongst other things, first rod 5′ differs in that it is threaded, and cylinder 17′ differs in that it has no fluid ports. Worm gear 49′, containing worm wheel 51′ (connected to first rod 5′ via threading) and worm 53′, translates rotational motion from motor 55′ to linear motion, thereby moving first rod 5′ and second rod 7′.

Overall, the system can be manufactured to withstand pressures significantly higher than the usual oil and gas pipeline pressure. A safety factor of at least 3 is desirable (meaning that for oil and gas pipelines, the seal is maintained at 4000 PSI), but the system can be manufactured to withstand higher line pressures, for example of up to about 10,000 PSI. This is due to the use of high-pressure o-rings, seals, wipers, and gaskets, which allow for a positive seal to be maintained throughout the retraction/extension process. As a result, there is no need to shut off the flow to a pipeline or drain the pipeline in order to retract the quill from within the pipeline for maintenance or for pigging the pipeline.

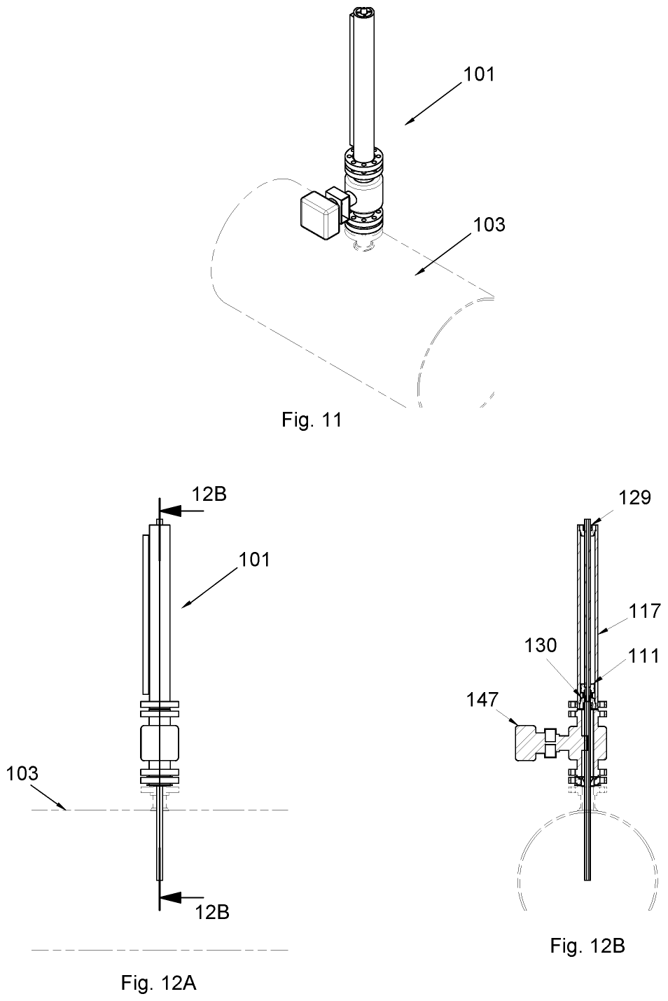

In a different embodiment, and as shown in FIGS. 11, 12A, 12B, 13A, 13B and 14, an injection quill 101 can be provided without the sleeve described above. Quill 101 having a hydraulic or pneumatic drive system may be attached to and encompass a reception point at a flange at pipe 103. This can, for example, be done by the use of nuts and bolts, with a gasket 104 provided between quill 101 and pipe 103 to establish a seal. Gasket 104 may be a Class 900 spiral wound gasket rated for an operating pressure of 2200 PSI (which, with safety factors, means the peak pressure rating is likely to surpass 4000 PSI). Gasket 104 may, for example, be a Flexitallic™ Spiral Wound Gasket. Quill 101 may be dimensioned such that it can be used with a flange already in place at pipe 103 (which may have, for example, been used with a quill as known in the prior art).

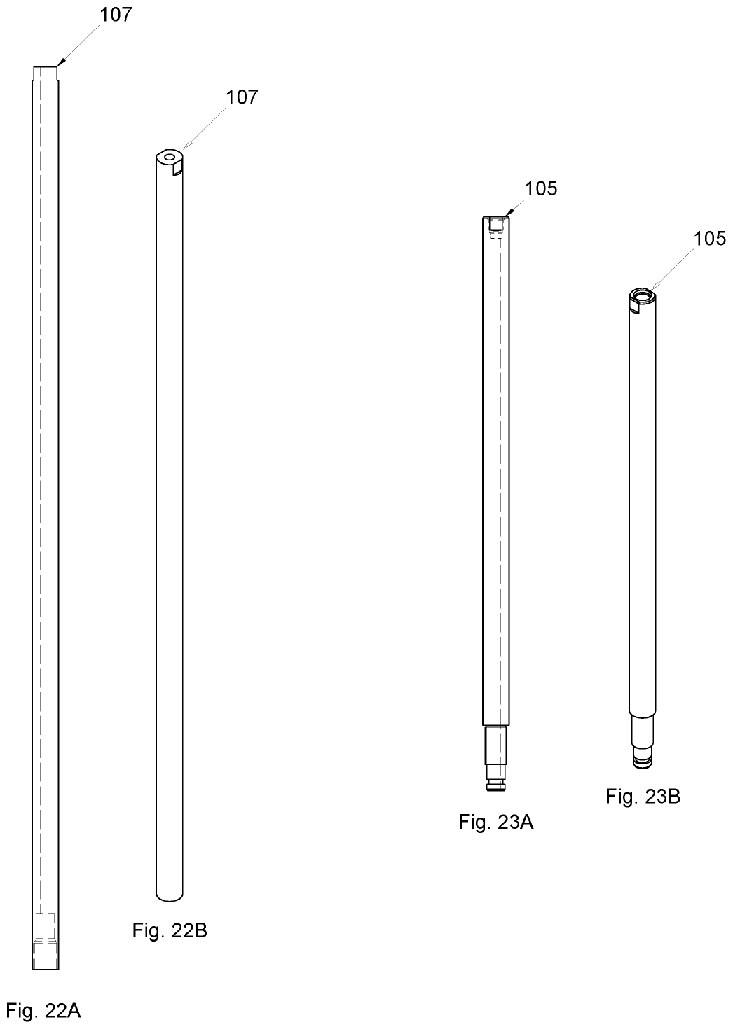

As shown in FIGS. 22A, 22B, 23A, and 23B, quill 101 comprises a hollow rod, which may be provided in the form of two hollow rods detachably connected to one another, first rod 105 and second rod 107. First rod 105 and second rod 107 may be made of 316 grade stainless steel, zinc plated carbon steel or any other material specially selected based on the application in which quill 101 will be used (for example, the material used may be selected based on its corrosion or abrasion resistance properties with respect to a particular chemical expected to be injected through quill 101 into pipe 103). As shown in FIGS. 13B and 15, first rod 105 and second rod 107 are connected together. This may, for example, be done by threading and using a groove with a seal, such as rod-rod seal 109, which may, for example, be a u-cup seal, to help seal the connection. The free end of second rod 107 extends into pipe 103 when quill 101 is in its extended position. In some embodiments, the free end of second rod 107 may be angled. Use of detachably connected first rod 105 and second rod 107 means that if second rod 107 becomes corroded it can easily be replaced.

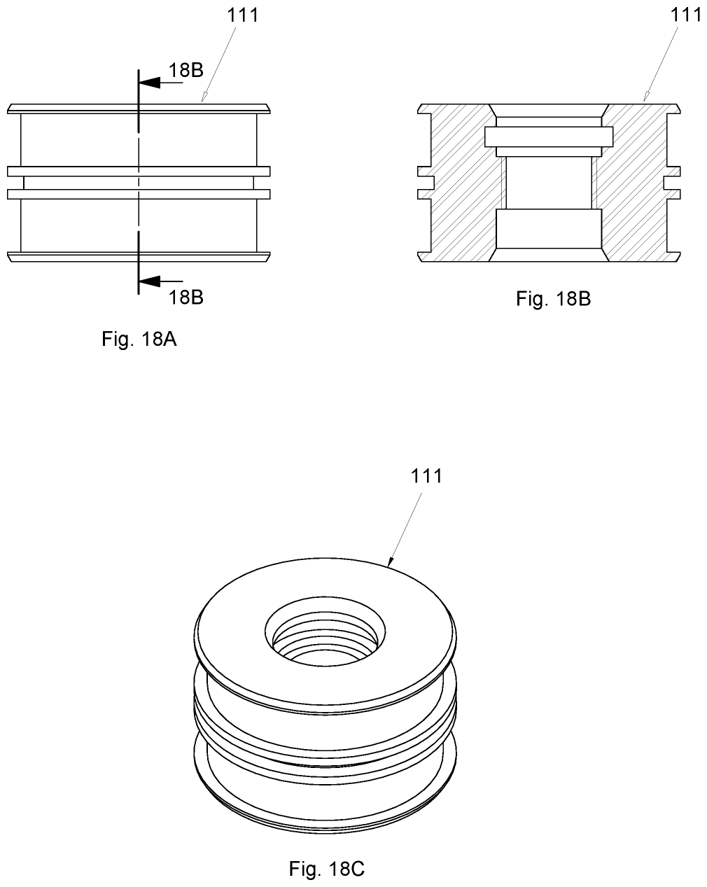

Piston 111, as shown in FIGS. 12B, 15, 18A, 18B, and 18C, may be provided on first rod 105 near the end of first rod 105 connected to second rod 107. Piston 111 may, for example, be made of Dura-Bar™ cast iron or 316 Stainless Steel. Piston 111 may be provided with one or more piston-cylinder seals 113, one or more piston-cylinder wear band seals 115, and/or one or more piston-rod seals 116 to provide sealing. The one or more piston-cylinder seals 113 and one or more piston-rod seals 116 may, for example, be u-cup seals.

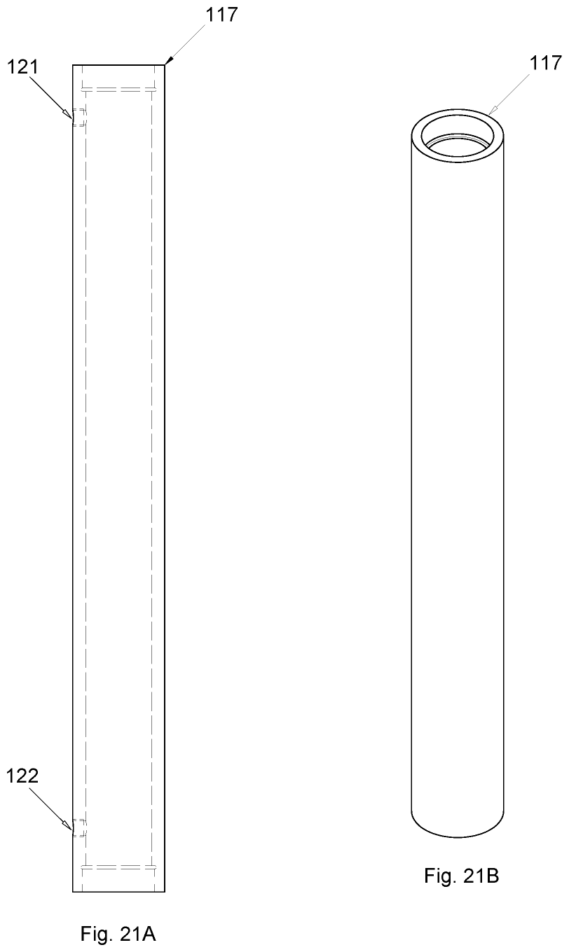

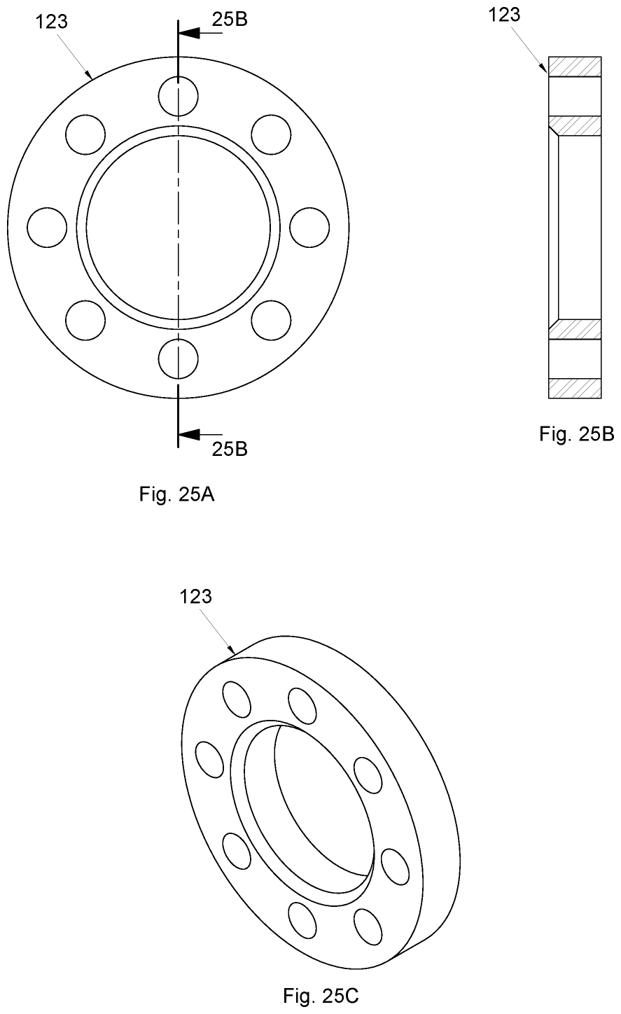

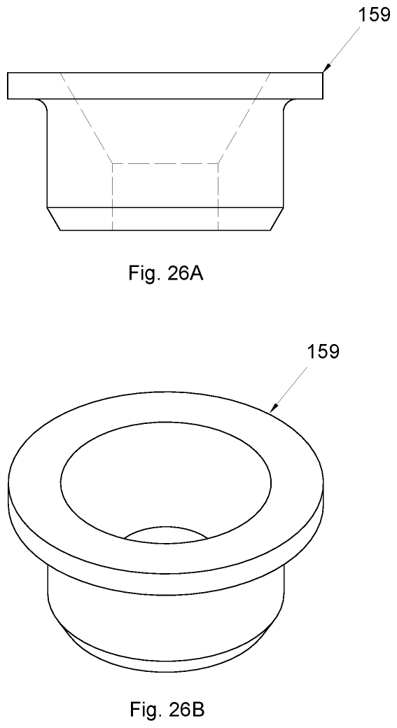

First rod 105 and second rod 107 with piston 111 are slidably disposed within cylinder 117, as shown in FIGS. 15, 16, 21A, 21B, 25A, 25B, and 25C. Cylinder 117 may also have upper port 121 and lower port 122 and a flange 123. Cylinder 117 may, for example, be made of A513 microhoned tubing. Flange 123 may be made of 44W grade steel or 316 Stainless Steel. Flange 123 and cylinder 117 may be manufactured separately and welded together.

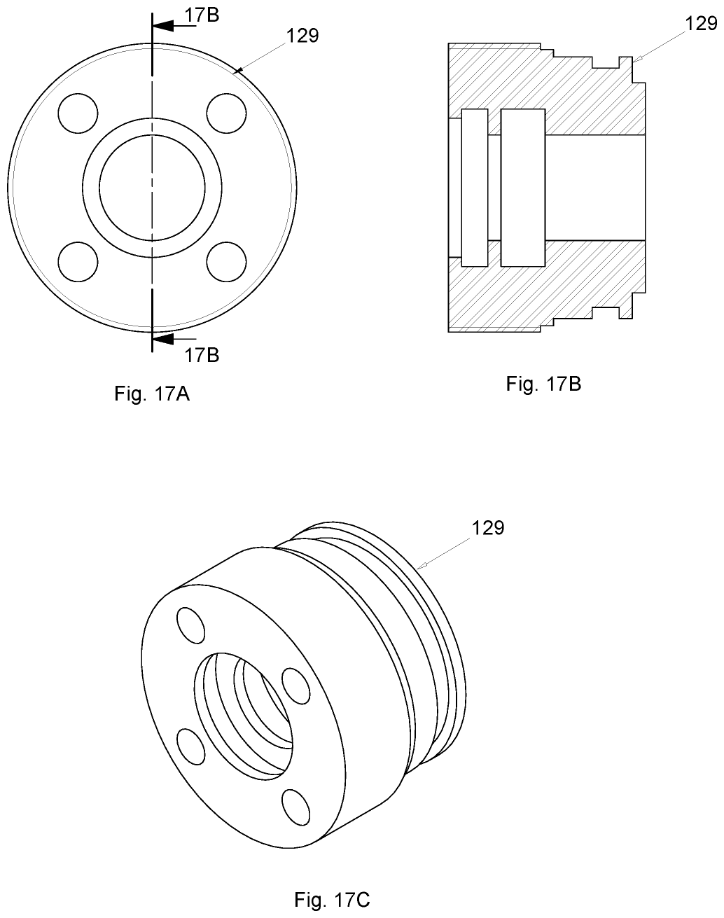

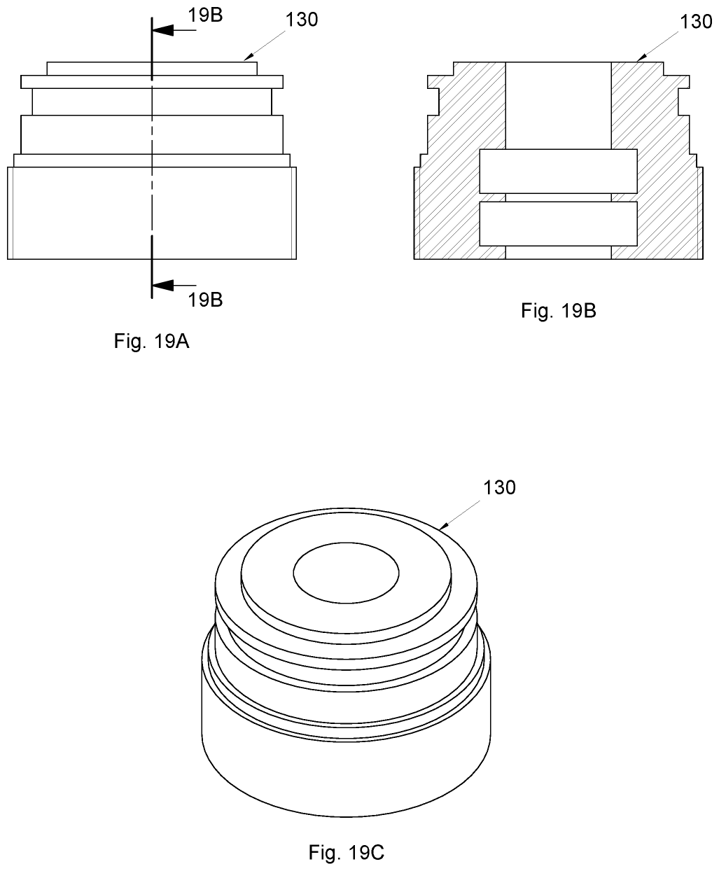

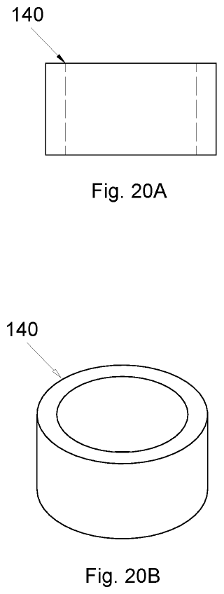

Upper cylinder gland 129 and lower cylinder gland 130, as shown in FIGS. 17A, 17B, 17C, 19A, 19B, and 19C, may be placed within cylinder 117 as shown in FIGS. 15 and 16, with upper cylinder gland 129 at the end of cylinder 117 farthest from pipe 103 after installation of quill 101, and lower cylinder gland 130 at the end of cylinder 117 closest to pipe 103 after installation of quill 101. Upper cylinder gland 129 and lower cylinder gland 130 may or may not be of the same shape and dimensions, and may or may not be made of the same material. Upper cylinder gland 129 and lower cylinder gland 130 may, for example, be made of SAE 660 grade bronze or 316 Stainless Steel. In some embodiments, upper cylinder gland 129 may have a gland-rod wiper seal 131. Upper cylinder gland 129 and lower cylinder gland 130 may each have one or more gland-cylinder seals 134, gland-rod wear band seals 136, and/or gland-cylinder seals 137, as shown in FIGS. 15 and 16. Gland-rod wiper seal 131, gland-cylinder seals 134, which may, for example, be o-rings, gland-rod wear band seals 136, and gland-cylinder seals 137, which may, for example, be u-cup seals, help to create a seal. Quill retaining ring 140, as shown in FIGS. 20A and 20B, may be located above lower cylinder gland 130.

A flexible injection (or sampling) line (not shown) may be attached to the free end of first rod 105, and used to inject chemicals into the pipeline (or to remove samples, in the case of a sampling quill). The free end of first rod 105 may be threaded to allow for a positive seal with the injection line.

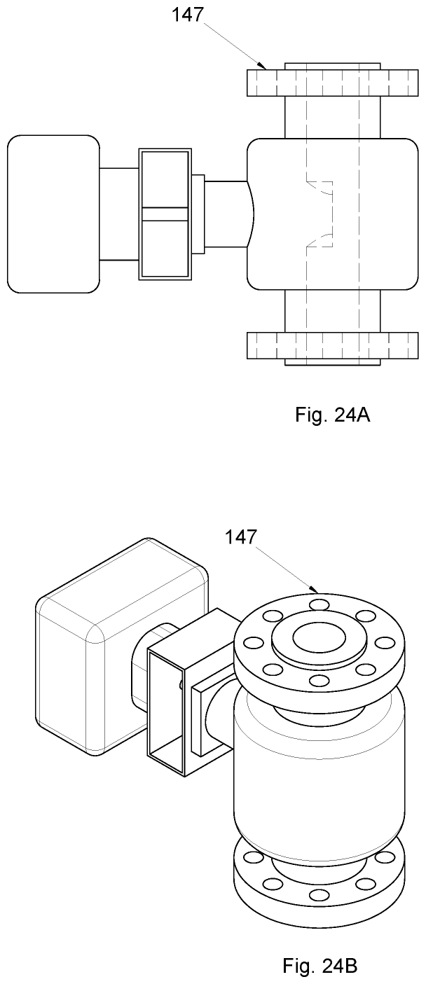

In some embodiments, an isolation valve 147, as shown in FIGS. 24A and 24B, may be added to quill 101. Isolation valve 147 may be a ball valve, such as the VSI-V-4-1010-X manufactured by Valve Solutions™ or the Atlas Series™ cast trunnion double block and bleed ball valve made by CNC Flow Control™. Isolation valve 147 may, for example, be solenoid-operated. When present, isolation valve 147 is located between cylinder 117 and pipe 103. Cylinder 117 and isolation valve 147 and may be connected by, for example, the use of nuts and bolts and optionally with gasket 148 for extra sealing. Gasket 148 may be a Class 900 spiral wound gasket rated for an operating pressure of 2200 PSI (which, with safety factors, means the peak pressure rating is likely to surpass 4000 PSI). Gasket 148 may, for example, be a Flexitallic™ Spiral Wound Gasket. Isolation valve 147 may be closed to allow for removal of quill 101 (or parts thereof) for maintenance without needing to shut off flow in the pipeline. In addition, isolation valve 147 may be closed when pigging the pipeline in order to help prevent debris within pipe 103 from entering quill 101. Use of a double block and bleed valve also allows one to purge any air that may be trapped within cylinder 117 during installation.

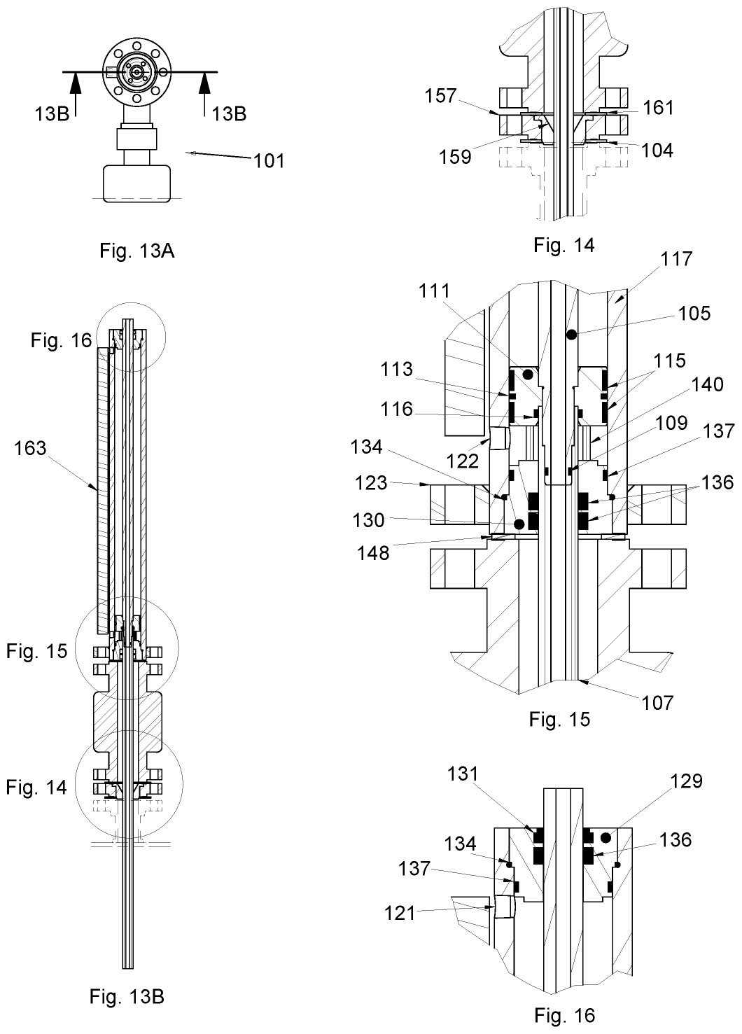

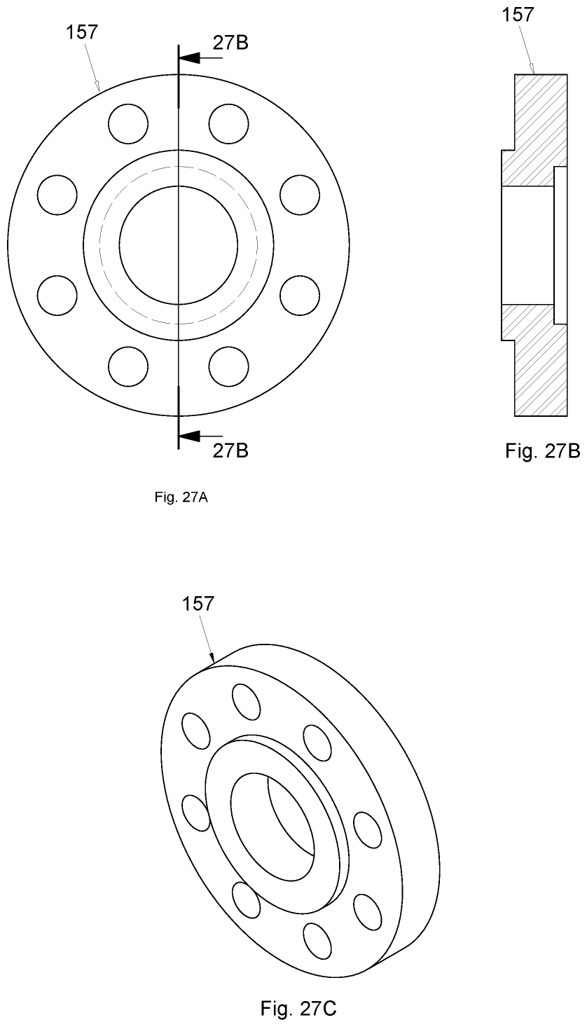

In some embodiments, dampener flange 157 holding velocity ring 159, as shown in FIGS. 14, 26A, 26B, 27A, 27B, and 27C, may be provided between isolation valve 147 and pipe 103. Isolation valve 147 and dampener flange 157 may be connected by, for example, the use of nuts and bolts and optionally with gasket 161 for extra sealing. Gasket 161 may be a Class 900 spiral wound gasket rated for an operating pressure of 2200 PSI (which, with safety factors, means the peak pressure rating is likely to surpass 4000 PSI). Gasket 161 may, for example, be a Flexitallic™ Spiral Wound Gasket. Velocity ring 159 dampens any vibration of first rod 105 and second rod 107 that may occur when second rod 107 is extended into pipe 103 and exposed to pressure from the flow in pipe 103.

In certain embodiments, and as shown in FIG. 13B, one or more position sensors may be added to quill 101 to track the position of quill 101 in its stroke, and in particular, how far it extends into pipe 103. Position sensors may be mounted internally or externally. For example, magnetostrictive external position sensor 163 can be used to identify the position of quill 101. The sensor may be mounted externally on the side of quill 101. One or more strong magnets (not shown), such as strong rare-earth magnets, may be installed around piston 111. This can be done, for example, by the use of pockets to house the magnets. In some embodiments, there may be eight or more magnets around piston 111. The externally mounted position sensor measures the position of the magnets through cylinder 117. Use of multiple magnets on piston 111 tends to provide more accurate measurements of the position of piston 111 in the case that piston 111 rotates over time. Use of a position sensor provides information that assists with remote operation of quill 101. In addition, it allows operators to know better where in the flow a chemical will be injected (or, in the case of a sampling quill, to know better where in the flow a sample is drawn from).

In some embodiments (not shown), RFID tags may be mounted on the exterior of cylinder 117 and used to store information such as maintenance data and location.

In some embodiments, a flushing system may be added to clean the quill. After retracting quill 101 and pigging the pipeline, debris may accumulate at isolation valve 147 or, in embodiments where there is no isolation valve, at cylinder 117. Before extending second rod 107 into pipe 103, one may first open isolation valve 147 (if present) and flush quill 101 with a flushing fluid before allowing second rod 107 to enter pipe 103. This tends to prevent debris from entering second rod 107. This flushing system may be automated.

In use, quill 101 may be operated via a hydraulic drive system (using, for example, oil) or a pneumatic drive system. Use of a hydraulic or pneumatic drive system allows for quill 101 to be automated and/or remotely operated. When present, isolation valve 147 may also be automatically and/or remotely operated, and may be opened before extension of quill 101. During extension of quill 101, fluid enters upper port 121 and exerts a force on piston 111, moving the piston 111 (and as a result, both of first rod 105 and second rod 107) and pushing fluid out of the lower port 122 until piston 111 contacts quill retaining ring 140. In the extended position, the free end of second rod 107 is inserted into pipe 103 and is within the pressurized fluid in pipe 103. Quill retaining ring 140 tends to prevent piston 111 from travelling too far when quill 101 extends into pipe 103, ensuring that piston 111 does not block lower port 122 (which, if it were blocked, would tend to prevent enough hydraulic fluid from entering cylinder 117 to build up the pressure necessary for quill 101 to later retract). During retraction of quill 101, fluid enters lower port 122 and exerts a force on piston 111, moving the piston 111 (and as a result, both of first rod 105 and second rod 107) and pushing fluid out of the upper port 121 until the piston contacts upper cylinder gland 129. In the retracted position, the free end of second rod 107 is no longer within pipe 103. Gland-rod wiper seal 131 acts to wipe first rod 105 and prevent dust and debris from entering cylinder 117 during piston strokes. When present, isolation valve 147 may be closed after retraction of quill 101.

Upper cylinder gland 129 and lower cylinder gland 130 (via gland-rod wiper seal 131, gland-cylinder seals 134, gland-rod wear band seals 136, and gland-cylinder seals 137) help to create a positive pressure seal at cylinder 117 during piston strokes. Additional sealing is provided by piston 111 (via piston-cylinder seal 113, piston-cylinder wear band seals 115, and piston-rod seal 116). The seal is maintained even when the quill is moved between its retracted and extended positions.

A sampling quill can be made in a similar fashion to the injection quill described above, but the free end of the second rod, which extends into the pipe when the quill is in its extended position, sometimes has a different configuration. In some embodiments, the free end of the second rod of a sampling quill has the same configuration as that shown for quill 101 above. In other embodiments, the free end of the second rod of a sampling quill is modified in order to increase turbulence, and may have small holes or perforations at the angled tip, or may have a tip shaped similar to a spoon.

In an alternate embodiment, the quill may have an electrical drive system, such as a servo drive system (not shown), rather than a hydraulic or pneumatic drive system. A servo drive can be used in many settings and can be beneficial particularly if the quill is expected to be operated at low temperatures at which a hydraulic drive can tend to be “sluggish”, such as below about −35° C. The skilled person will understand how to modify the quill described above to use a servo drive.

Overall, the system can be manufactured to withstand pressures significantly higher than usual oil and gas pipeline pressure. A safety factor of at least 3 is desirable (meaning that for oil and gas pipelines, the seal is maintained at 4000 PSI), but the system can be manufactured to withstand higher line pressures, for example of up to about 10,000 PSI. This is due to the use of high-pressure seals and gaskets, which allow for a positive seal to be maintained throughout the retraction/extension process. As a result, there is no need to shut off the flow to a pipeline or drain the pipeline in order to retract the quill from within the pipeline for maintenance or for pigging the pipeline.

The abbreviation mm as used herein refers to millimetres (or in the US, “millimeters”). The abbreviation cm as used herein refers to centimetres (or in the US, “centimeters”).

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed. Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

1. A retractable quill for use with a pipe or vessel containing a fluid, the pipe or vessel being configured to receive a hollow rod of the retractable quill at a reception point, the retractable quill comprising:
a cylinder having a first end and a second end;
the hollow rod slidably disposed within the cylinder, the hollow rod having a first end configured to extend through the second end of the cylinder and be inserted into the pipe or vessel at the reception point in fluid communication with the fluid; and
a drive system configured to move the hollow rod within the cylinder between an extended position where the first end of the hollow rod is inserted into the pipe or vessel and within the fluid and a retracted position where the first end of the hollow rod is outside of the pipe or vessel;
wherein the retractable quill is configured to attach to the pipe or vessel and encompass the reception point.

2. The retractable quill of claim 1, wherein the second end of the cylinder is configured to attach to the pipe or vessel and encompass the reception point.

3. The retractable quill of claim 1, further comprising:
a dampener flange connected to the second end of the cylinder; and
a velocity ring provided in the dampener flange,
wherein the dampener flange is configured to attach to the pipe or vessel and encompass the reception point.

4. The retractable quill of claim 1, further comprising an isolation valve connected to the second end of the cylinder, wherein the isolation valve is configured to attach to the pipe or vessel and encompass the reception point.

5. The retractable quill of claim 1, further comprising:
an isolation valve having a first end and a second end, the first end of the isolation valve connected to the second end of the cylinder;
a dampener flange connected to the second end of the isolation valve; and
a velocity ring provided in the dampener flange,
wherein the dampener flange is configured to attach to the pipe or vessel and encompass the reception point.

6. The retractable quill of claim 1, wherein the pipe or vessel is pressurizable, and the retractable quill is configured to maintain a positive pressure seal when the hollow rod is moved between the extended position and the retracted position.

7. The retractable quill of claim 6, wherein the retractable quill maintains a positive pressure seal when the fluid is at a pressure of up to at least 2200 PSI.

8. The retractable quill of claim 1, wherein the retractable quill is an injection quill or a sampling quill.

9. The retractable quill of claim 1, wherein the drive system is remote-controlled and/or automated.

10. The retractable quill of claim 1, wherein the drive system is a hydraulic drive, a pneumatic drive, or an electrical drive.

11. The retractable quill of claim 10, wherein the electrical drive is a servo drive.

12. The retractable quill of claim 1, wherein the hollow rod comprises a first rod and a second rod that are detachably connected to one another.

13. The retractable quill of claim 4, wherein the isolation valve is remote-controlled and/or automated.

14. The retractable quill of claim 4, wherein the isolation valve is a double block and bleed ball valve.

15. The retractable quill of claim 1, further comprising one or more position sensors to track the position of the hollow rod as it moves between the extended position and the retracted position.

16. The retractable quill of claim 1, further comprising an RFID tag.

17. A method of operating the retractable quill of claim 1, comprising:
moving the hollow rod from the retracted position to the extended position using the drive system;
either injecting a chemical into the fluid or removing a sample from the fluid; and
moving the hollow rod from the extended position to the retracted position using the drive system,
wherein the drive system is remote-controlled and/or automated.

18. The method of claim 17, wherein the pipe or vessel is pressurizable, and the retractable quill is configured to maintain a positive pressure seal when the hollow rod is moved between the extended position and the retracted position.

19. A method of operating the retractable quill of claim 4, comprising:
opening the isolation valve;
moving the hollow rod from the retracted position to the extended position using the drive system;
either injecting a chemical into the fluid or removing a sample from the fluid;
moving the hollow rod from the extended position to the retracted position using the drive system; and
dosing the isolation valve,
wherein the drive system is remote-controlled and/or automated, and
further wherein the isolation valve is remote-controlled and/or automated.

20. The method of claim 9, wherein the pipe or vessel is pressurizable, and the retractable quill is configured to maintain a positive pressure seal when the hollow rod is moved between the extended position and the retracted position.
